(19) United States
(12) Patent Application Publication
(10) Pub. No.: US 2021/0048599 A1
(43) Pub. Date: Feb. 18, 2021

(54) LENS MODULE AND LENS MOUNT

(71) Applicant: Newmax Technology Co., Ltd., Taichung City (TW)

(72) Inventor: Yung-Fu Liang, Taichung City (TW)

(21) Appl. No.: 16/542,661

(22) Filed: Aug. 16, 2019

(51) Int. Cl. G02B 7/02

(52) U.S. Cl. CPC G02B 7/026

(57) ABSTRACT

A lens module includes a lens mount, at least one lens, and a positioning ring. The lens mount has a first end and a second end along an axial direction, and the inner peripheral face thereof has a positioning section near the first end. The lens and the positioning ring are arranged inside the lens mount. An outer peripheral face of the positioning ring is connected to the positioning section to prevent the lens from falling out. An end of one of the positioning section and the outer peripheral face of the positioning ring near the first end is formed with at least one groove which is open toward the first end for injecting with adhesive. An axial length of the groove is smaller than an axial length of the outer peripheral face of the positioning ring.

### BACKGROUND OF THE INVENTION

### Field of the Invention

The present invention relates to a lens module and a lens mount.

### Description of the Prior Art

A lens module is usually composed of a lens mount and a plurality of lenses. The lens mount has plural stepped faces on the inner peripheral face for the lenses to abut against in order to make the positions of the lenses precise. A positioning ring fixed at an end of the lens mount having a larger inner diameter is often used to prevent the lens from falling for protection.

The positioning ring is usually positioned to the lens mount by tight-fitting or engaging structure. Patent TW 1616698 disclosed another means to position the positioning ring. The inner peripheral face of the lens mount is formed with plural grooves extending axially, and the grooves are injected with adhesive to fix the positioning ring.

However, the structure has at least two disadvantages. First, the adhesive may reach the other side of the positioning ring to contaminate the lenses. Second, the contact area between the positioning ring and the lens mount is reduced because of the grooves. When the adhesive deteriorates, the positioning ring may fall from the lens mount.

### SUMMARY OF THE INVENTION

The main object of the present invention is to provide a lens module and a lens mount for positioning the positioning ring on the lens mount tightly and to prevent the adhesive from reaching the lens.

To achieve the above and other objects, the lens module of the present invention includes a lens mount, at least one lens, and a positioning ring.

The lens mount is cylinder-shaped and has an inner peripheral face. A receiving space is enclosed by the inner peripheral face. The lens mount has a first end and a second end along an axial direction thereof The inner peripheral face has a positioning section near the first end. The at least one lens is arranged in the receiving space. An outer peripheral face of the at least one lens contacts the inner peripheral face of the lens mount. The positioning ring is arranged in the receiving space. An outer peripheral face of the positioning ring is connected to the positioning section of the lens mount to prevent the at least one lens from falling out via the first end of the lens mount. An end of at least one of the positioning section and the outer peripheral face of the positioning ring near the first end is formed with at least one groove. The at least one groove is open toward the first end. A length of the at least one groove along the axial direction is smaller than a length of the outer peripheral face of the positioning ring along the axial direction. The at least one groove is injected with an adhesive for engagement between the outer peripheral face of the positioning ring and the inner peripheral face of the lens mount.

To achieve the above and other objects, the present invention also provides a lens mount. The lens mount is cylinder-shaped and has an inner peripheral face. A receiving space is enclosed by the inner peripheral face for receiving at least one optical element. The lens mount has a first end and a second end along an axial direction thereof The inner peripheral face has a positioning section near the first end. The positioning section is adapted for an outer peripheral face of the at least one optical element to contact and connect. The positioning section has at least one groove. The at least one groove is open at an end thereof near the first end of the lens mount. The at least one groove has a length along the axial direction smaller than a length of the outer peripheral face of the at least one optical element along the axial direction. The at least one groove is adapted for being injected with an adhesive for engagement between the outer peripheral face of the at least one optical element and the inner peripheral face of the lens mount.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a lens mount and a positioning ring of the present invention;

FIG. 2 is a breakdown drawing showing a lens mount and a positioning ring of the present invention;

FIG. 3 is a stereogram of the present invention;

FIG. 4 is a profile of the present invention;

FIG. 5 is a partial enlargement of FIG. 4;

FIG. 6 is an illustration of adhesive injection of the present invention;

FIG. 7 is a partial profile showing a second embodiment of the present invention;

FIG. 8 is a partial profile showing a third embodiment of the present invention;

FIG. 9 is a partial profile showing a fourth embodiment of the present invention;

FIG. 10 is a partial profile showing a fifth embodiment of the present invention;

FIG. 11 is a partial enlargement of FIG. 10.

### DETAILED DESCRIPTION OF THE PREFERRED EMBODIMENTS

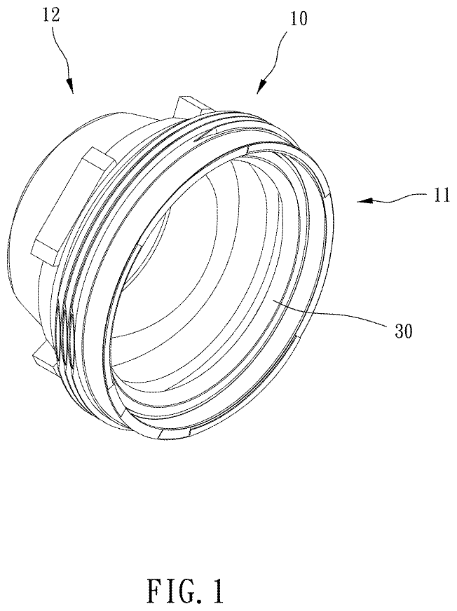

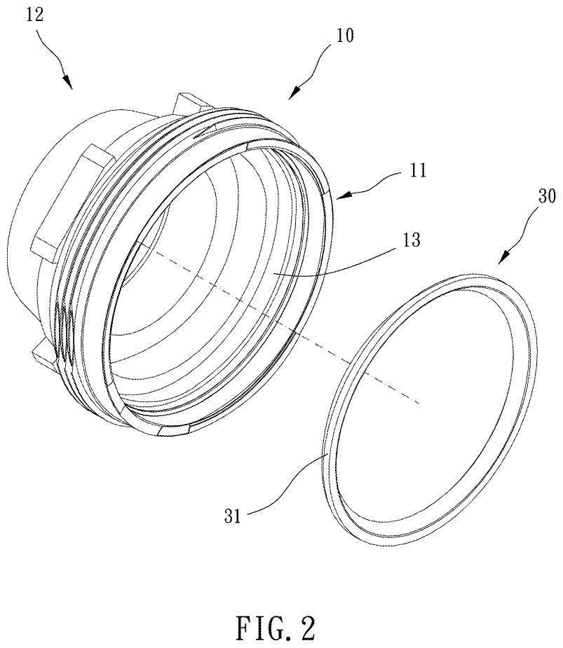

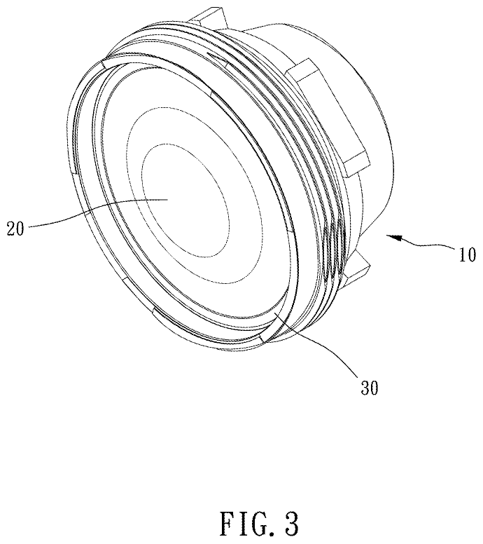

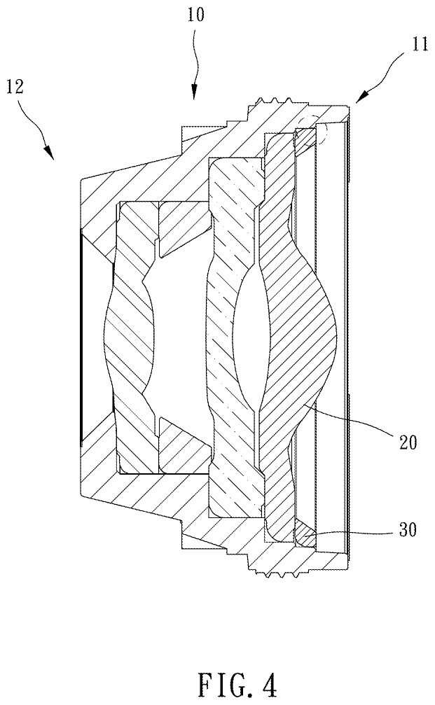

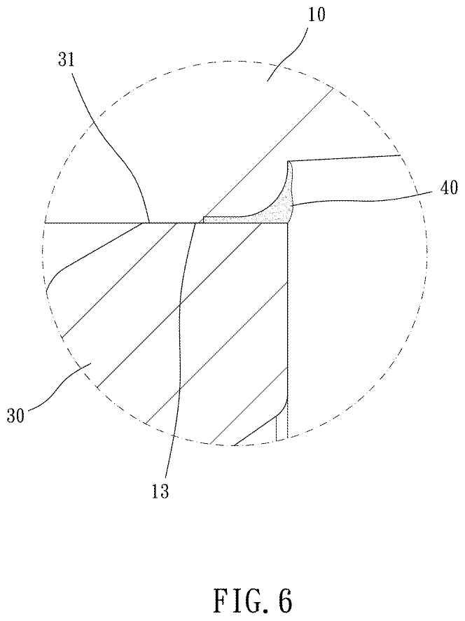

Please refer to FIG. 1 to FIG. 11, the lens module of the present invention includes a lens mount 10,10a,10b,10c,10d, at least one lens 20, and a positioning ring 30,30a.

The lens mount 10,10a,10b,10c,10d is cylinder-shaped and has an inner peripheral face. A receiving space is enclosed by the inner peripheral face. The lens mount 10,10a,10b,10c,10d has a first end 11 and a second end 12 along an axial direction thereof The inner peripheral face has a positioning section 13,13a,13b,13c,13d near the first end 11. The at least one lens 20 is arranged in the receiving space. An outer peripheral face of the at least one lens 20 contacts the inner peripheral face of the lens mount 10,10a,10b,10c,10d. The positioning ring 30,30a is arranged in the receiving space. An outer peripheral face 31,31a of the positioning ring 30,30a is connected to the positioning section 13,13a,13b,13c,13d of the lens mount 10,10a,10b,10c,10d to prevent the at least one lens 20 om falling out via the first end 11 of the lens mount 10,10a,10b,10c,10d. An end of at least one of the positioning section 13,13a,13b,13c,13d and the outer peripheral face 31,31a of the positioning ring 30,30a near the first end 11 is formed with at least one groove 14,32,14b,14c,14d. The at least one groove 14,32,14b,14c,14d is open toward the first end 11. A length of the at least one groove 14,32,14b,14c,14d along the axial direction is smaller than a length of the outer peripheral face 31,31a of the positioning ring 30,30a along the axial direction. The at least one groove 14,32,14b,14c,14d is injected with an adhesive 40 for engagement between the outer peripheral face 31,31a of the positioning ring 30,30a and the inner peripheral face of the lens mount 10,10a,10b,10c,10d. Preferably, the at least one groove 14,32,14b,14c,14d has a depth H1,H2,H3,H4 along a radial direction of the lens mount 10,10a,10b,10c,10d ranged between 2 micrometers to 300 micrometers. The present invention also provides a lens mount 10,10b,10c,10d. The lens mount 10,10b,10c,10d is cylinder-shaped and has an inner peripheral face. A receiving space is enclosed by the inner peripheral face for receiving at least one optical element (such as a lens, a spacer, or a positioning ring). The lens mount 10,10b,10c,10d has a first end 11 and a second end 12 along an axial direction thereof The inner peripheral face has a positioning section 13,13a,13c,13d near the first end 11. The positioning section 13,13a,13c,13d is adapted for an outer peripheral face of the at least one optical element to contact and connect. The positioning section 13,13a,13c,13d has at least one groove 14,14b,14c,14d. The at least one groove 14,14b,14c,14d is open at an end thereof near the first end 11 of the lens mount 10,10b,10c,10d. The at least one groove 14,14b,14c,14d has a length along the axial direction smaller than a length of the outer peripheral face of the at least one optical element along the axial direction. The at least one groove 14,14b,14c,14d is adapted for being injected with an adhesive 40 for engagement between the outer peripheral face of the at least one optical element and the inner peripheral face of the lens mount 10, 10b,10c,10d.

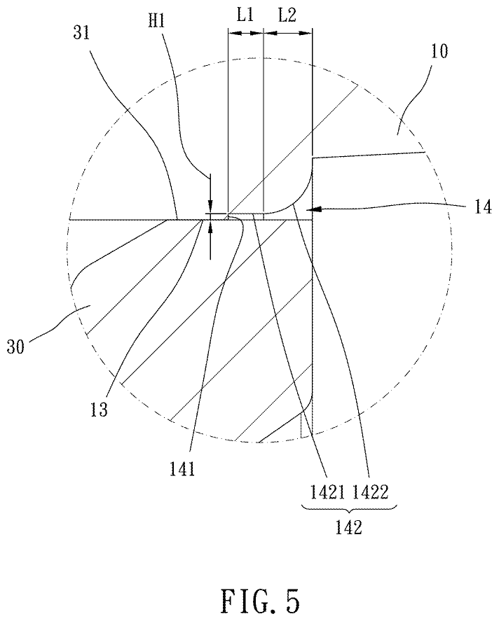

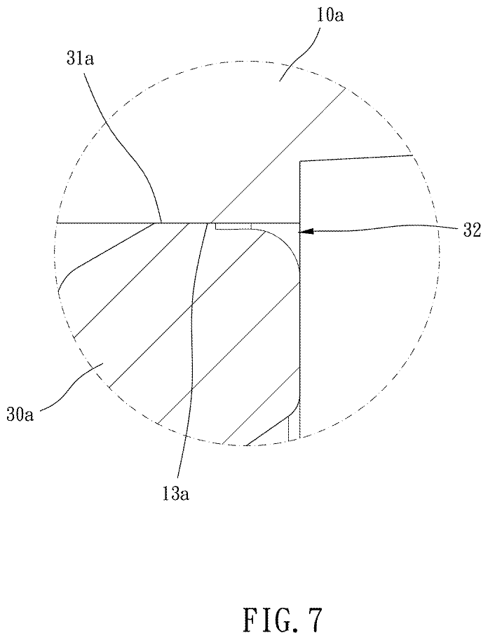

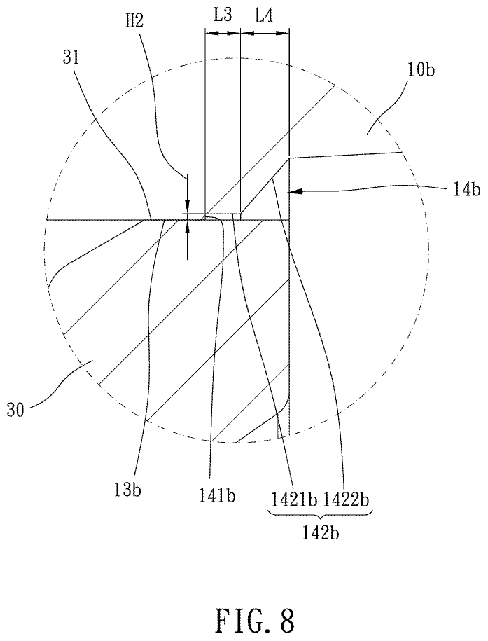

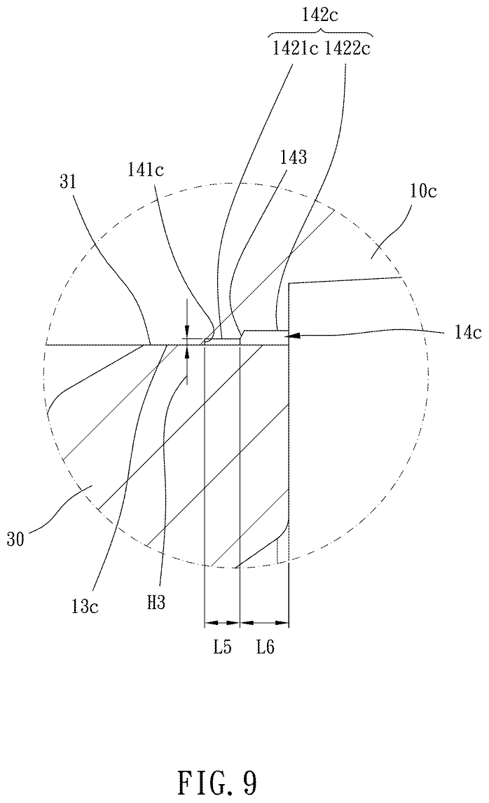

In the present embodiment, the at least one groove 14,32,14b,14c,14d extends around the axial direction to be annular-shaped. In addition, the at least one groove 14,32,14b,14c,14d is enclosed by a lateral wall 142,142b,142c,142d and a bottom face 141,141b,141c,141d. The bottom face 141,141b,141c,141d is connected to a side of the lateral wall 142,142b,142c,142d near the second end 12. Specifically, the lateral wall 142,142b,142c,142d of the at least one groove 14,32,14b,14c,14d includes a bottom section 1421,1421b,1421c,1421d and a top section 1422,1422b,1422c,1422d aligned along the axial direction. The bottom section 1421,1421b,1421c,1421d is connected to the bottom face 141,141b,141c,141d. The top section 1422,1422b,1422c,1422d is located at a side of the bottom section 1421,1421b,1421c,1421d remote from the bottom face 141,141b,141c,141d. An inner diameter of the top section 1422,1422b,1422c,1422d is increasing toward the first end 11. For example, the top section 1422 can have a radial cross-section which is convex arc-shaped, as shown in FIG. 5 or FIG. 7. The top section 1422b can be a conical face, as shown in FIG. 8. In other embodiments, the top section 1422c has a larger inner diameter than an inner diameter of the bottom section 1421c so that a stepped face 143 is formed between the top section 1422c and the bottom section 1421c, as shown in FIG. 9. Thereby, the groove has a larger opening for injecting the adhesive. Preferably, the stepped face 143 is oblique with respect to a radial direction of the lens mount 10c to face the first end of the lens mount 10c. Thereby, the adhesive can easily flow to the bottom section 1421c from the top section 1422c.

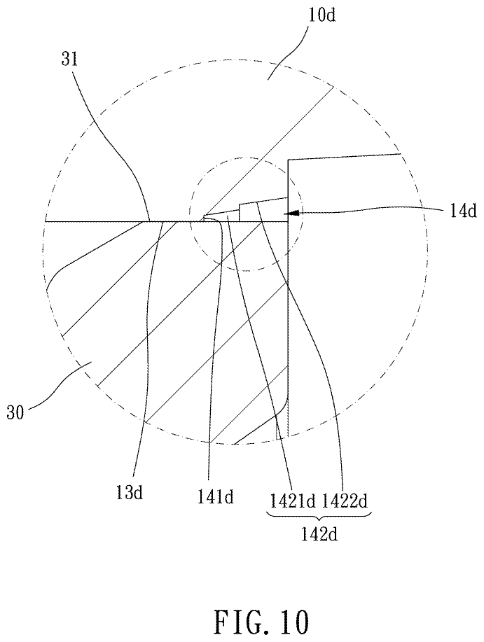

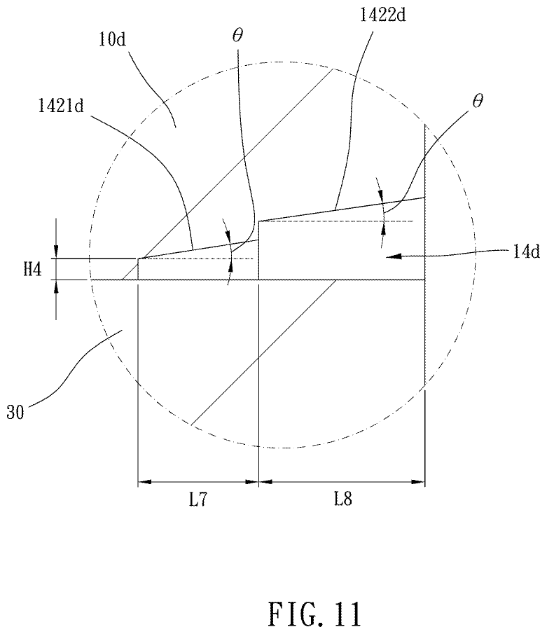

Please refer to FIG. 10 and FIG. 11. In this embodiment, each of the bottom section 1421d and the top section 1422d is oblique with respect to the axial direction of the lens mount 10d to face the first end of the lens mount 10d. That is, there are two divergent sections toward the first end. Preferably, an angle θ between the axial direction of the lens mount 10d and each of the bottom section 1421d and the top section 1422d is larger than 0 degree but smaller than 30 degrees.

More preferably, the axial length L1,L2,L3,L4,L5,L6,L7,L8 of each of the bottom section 1421,1421b,1421c,1421d and the top section 1422,1422b,1422c,1422d is ranged from 2 micrometers to 300 micrometers. Specifically, in the present embodiment, the groove 14,14b,14c,14d is formed on the lens mount 10. However, as shown in FIG. 7, the groove 32 can be formed on the outer peripheral face 31a of the positioning ring 30a.

In conclusion, the groove of the present invention can be used to receive adhesive for engagement between the positioning ring and the lens mount. Because the groove doesn't extend beside the lens, the adhesive may not reach the lens. Besides, there is no groove formed on the outer peripheral face of the positioning ring near the second end so that the positioning ring and the lens mount have a large contact area to fix them firmly.

What is claimed is:

1. A lens module, including:
a lens mount, being cylinder-shaped and having an inner peripheral face, a receiving space being enclosed by the inner peripheral face, the lens mount having a first end and a second end along an axial direction thereof, the inner peripheral face having a positioning section near the first end;
at least one lens, arranged in the receiving space, an outer peripheral face of the at least one lens contacting the inner peripheral face of the lens mount;
a positioning ring, arranged in the receiving space, an outer peripheral face of the positioning ring being connected to the positioning section of the lens mount to prevent the at least one lens from falling out via the first end of the lens mount;
wherein an end of at least one of the positioning section and the outer peripheral face of the positioning ring near the first end is formed with at least one groove, the at least one groove is open toward the first end, a length of the at least one groove along the axial direction is smaller than a length of the outer peripheral face of the positioning ring along the axial direction, the at least one groove is injected with an adhesive for engagement between the outer peripheral face of the positioning ring and the inner peripheral face of the lens mount.

2. The lens module of claim 1, wherein the at least one groove extends around the axial direction to be annular-shaped.

3. The lens module of claim 2, wherein the at least one groove is enclosed by a lateral wall and a bottom face, the bottom face is connected to a side of the lateral wall near the second end.

4. The lens module of claim 3, wherein the lateral wall of the at least one groove includes a bottom section and a top section aligned along the axial direction, the bottom section is connected to the bottom face, the top section is located at a side of the bottom section remote from the bottom face, an inner diameter of the top section is increasing toward the first end.

5. The lens module of claim 4, wherein the top section has a radial cross-section which is convex arc-shaped.

6. The lens module of claim 4, wherein the top section is a conical face.

7. The lens module of claim 3, wherein the lateral wall of the at least one groove includes a bottom section and a top section aligned along the axial direction, the bottom section is connected to the bottom face, the top section is located at a side of the bottom section remote from the bottom face, the top section has a larger inner diameter than an inner diameter of the bottom section so that a stepped face is formed between the top section and the bottom section.

8. The lens module of claim 7, wherein the stepped face is oblique with respect to a radial direction of the lens mount to face the first end of the lens mount.

9. The lens module of claim 7, wherein each of the bottom section and the top section is oblique with respect to the axial direction of the lens mount to face the first end of the lens mount.

10. The lens module of claim 9, wherein an angle between the axial direction of the lens mount and each of the bottom section and the top section is larger than 0 degree but smaller than 30 degrees.

11. The lens module of claim 1, wherein the at least one groove has a depth along a radial direction of the lens mount ranged between 2 micrometers to 300 micrometers.

12. A lens mount, being cylinder-shaped and having an inner peripheral face, a receiving space being enclosed by the inner peripheral face for receiving at least one optical element, the lens mount having a first end and a second end along an axial direction thereof, the inner peripheral face having a positioning section near the first end, the positioning section being adapted for an outer peripheral face of the at least one optical element to contact and connect, the positioning section having at least one groove, the at least one groove being open at an end thereof near the first end of the lens mount, the at least one groove having a length along the axial direction smaller than a length of the outer peripheral face of the at least one optical element along the axial direction, the at least one groove is adapted for being injected with an adhesive for engagement between the outer peripheral face of the at least one optical element and the inner peripheral face of the lens mount.

13. The lens mount of claim 12, wherein the at least one groove extends around the axial direction to be annular-shaped.

14. The lens mount of claim 13, wherein the at least one groove is enclosed by a lateral wall and a bottom face, the bottom face is connected to a side of the lateral wall near the second end.

15. The lens mount of claim 14, wherein the lateral wall of the at least one groove includes a bottom section and a top section aligned along the axial direction, the bottom section is connected to the bottom face, the top section is located at a side of the bottom section remote from the bottom face, an inner diameter of the top section is increasing toward the first end.

16. The lens mount of claim 15, wherein the top section has a radial cross-section which is convex arc-shaped.

17. The lens mount of claim 15, wherein the top section is a conical face.

18. The lens mount of claim 14, wherein the lateral wall of the at least one groove includes a bottom section and a top section aligned along the axial direction, the bottom section is connected to the bottom face, the top section is located at a side of the bottom section remote from the bottom face, the top section has a larger inner diameter than an inner diameter of the bottom section so that a stepped face is formed between the top section and the bottom section.

19. The lens mount of claim 18, wherein the stepped face is oblique with respect to a radial direction of the lens mount to face the first end of the lens mount.

20. The lens mount of claim 18, wherein each of the bottom section and the top section is oblique with respect to the axial direction of the lens mount to face the first end of the lens mount.

21. The lens mount of claim 20, wherein an angle between the axial direction of the lens mount and each of the bottom section and the top section is larger than 0 degree but smaller than 30 degrees.

22. The lens mount of claim 12, wherein the at least one groove has a depth along a radial direction of the lens mount ranged between 2 micrometers to 300 micrometers.
